(19) United States
(12) Patent Application Publication
(10) Pub. No.: US 2006/0184390 A1
(43) Pub. Date: Aug. 17, 2006

(54) Perfect system of compensations for physicians

(76) Inventor: Anuthep Benja-Athon, New York, NY (US)

Correspondence Address: ANUTHEP BENJA-ATHON;Gr. FLOOR, 210 E 36th St., New York, NY, 10016, US

(21) Appl. No.: 11/242,461

(22) Filed: Oct. 4, 2005

Related U.S. Application Data
(63) Continuation-in-part of application No. 11/150,878, filed on Jun. 13, 2005.
Application No. 11/150,878 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G06Q 10/00

(52) U.S. Cl. 705/2

(57) ABSTRACT

A system of computerized utilizations of physicians' decisions contain in physician-generated digital health and health-care information arrived and stored in designated computers or servers wherein physicians' decisions computer-automatically direct the utilizations of health and health-care information and data to produce outcomes leading to payments to appropriate physicians.

This application is a continuation-in-part of Ser. No. 11/150,878 entitled Physician's Optimal Management of Health Information filed Jun. 13, 2005 which is a continuation-in-part of U.S. Ser. No. 11/114,763 entitled A System of Influencing Health-Care Utilizations filed Apr. 27, 2005 which is a continuation-in-part of U.S. Ser. No. 11/074,236 entitled the System of Management of Health-Care Resources filed Mar. 7, 2005 and U.S. Ser. No. 11/059,088 entitled the Consumers-Buyers-Physicians Health-Care filed Feb. 16, 2005 which are pending.

### FIELD OF INVENTION

A computerized system of compensations for physicians.

### BACKGROUND OF THE INVENTION

Each day billions of health-care dollars intended to serve patients and physicians are removed or lost from the proper health-care system. Said losses make the current 1.7-trillion-dollar-per-annum American health-care system an extremely, if not the most, inefficient and one of the costliest enterprises in the world. Consequently, the tragic consequences to tens of millions of Americans are too numerous to be accounted for. The reasons can be summed up that there are numerous points within the current health-care finance system where health-care dollars are removed from or siphoned off the main proper health-care channel in which health-care dollars are productively used. In other words, health-care consumers and buyers do not get to use their health-care monies to benefit themselves and physicians do not receive health-care monies to compensate for their works. Even if the above losses from the health-care system are obvious to many, there was heretofore neither a system nor means for preventing said losses.

The present invention provides the perfect system for reducing or preventing said losses.

More specifically, the present invention is the perfect system for directing health-care money to appropriately pay or compensate physicians and other health-care providers for their services and cares for patients and reducing or preventing said losses to health-care consumers and buyers.

In other words, the present invention assists other pending patents of these applicants to effectively curb or prevent billions of dollars of waste, frauds and losses by health-care consumers and buyers and at least 500,000 physicians each year in America which could not be heretofore achieved by any prior art systems and means.

### SUMMARY OF THE INVENTION

Each day billions of health-care dollars intended to serve patients and physicians are removed or lost from the proper health-care system and America had heretofore neither a system nor means to curb or prevent said losses.

The present invention solves the above problems. The present invention is a system of computerized utilizations of physicians' decisions contain in physician-generated digital health and health-care information on physicians' patients in a computer or computers in a network of computers for computer-automatically effecting outcomes leading to payments to appropriate said physicians for health-care services rendered by said physicians to said patients wherein said utilizations are directed in said computer or computers by said physicians' decisions in said physician-generated digital health and health-care information.

### DESCRIPTION OF THE PREFERRED EMBODIMENTS

The present invention is a system of computerized or computer-automated utilizations of physicians' decisions on the cares of their patients which are created by said physicians and contained in said physicians' physician-generated digital health and health-care information on their patients for effecting outcomes relating to the monetary values of their health-care services. In certain designated computer or computers in a network of computers, said utilizations are automatically directed by said physicians' decisions, judgements, conclusions or inferences on medicine, surgery and clinical subjects relating to their patients such as, but not limited to, patients' chief complaints, diagnoses, treatments, procedures, tests and surgeries in said physician-generated digital health and health-care information to automatically generate said outcomes without human interference. Said physicians' decisions, judgements, conclusions or inferences are expressed in a word or words comprising alphabets, numbers, alphanumerics or any combination thereof. Said outcomes lead to payments to appropriate said physicians for their health-care services rendered by said physicians to said patients. Furthermore, said outcomes and payments to appropriate said physicians are viewed by physicians and health-care consumers and buyers on their computer display screens.

According to the teaching in the pending patent applications in 2005 of this patent applicant and his patent co-applicant, said physician-generated digital health and health-care information on patients are created or generated by physicians in diverse locations. According to said pending patent applications, from the inceptions of said health and health-care information on said patients in said physicians' brains to said physicians' articulations of voices comprising said information into said physicians' digital voice recorders (DVR) which record said voices in digital voice files to computer-production of outcomes comprising the matches or merges certain components of digital health and health-care information in digital text files to appropriate prices in certain designated, remote computer or computers in said network of computers, said information are handled, processed and the objectives are achieved by said designated computer or computers in said network of computers using computer software designed to achieve the objectives.

The memories or caches of certain designated computer/server or computers/servers in said network of computers store computer files comprising health and health-care information based on categories such as, but not limited to, chief complaints, diagnosis, treatments, procedures, tests and surgeries. Said digital categories comprise almost all or all—i.e. tens of thousands of members—chief complaints, diagnosis, treatments, procedures, surgeries and tests in all 70 medical and surgical specialties such as, but not limited to, allergy, gastroenterology, infectious disease, internal medicine, neurology, pain medicine, rheumatology and urology. Furthermore, said categories may be further organized or subcategorized into classes, subclasses, groups or subgroups of chief complaints, diagnosis, treatments, procedures and surgeries in all 70 medical and surgical specialties. Furthermore, each member of said digital categories is expressed in a word or words comprising alphabets, numbers, alphanumerics or any combination thereof. Furthermore, said attributes of words, numbers, alphanumerics or any combination thereof representing chief complaints, diagnosis, treatments, procedures, tests, surgeries or any combination thereof are generated by said physicians, according to said teachings in said pending patent applications, at the generation or creation of said digital health and health-care information.

In addition, said memories or caches of certain designated computer/server or computers/servers store computer files comprising said health and health-care information categories wherein each member or group of members bears a price or is tagged with a price or a monetary value. For example, “cold” or a numeral code representation such as “101” is a diagnosis which is assigned or tagged with a value of $30, “flu” or a numeral code representation such as “102” is a diagnosis which is assigned a value of $40; “injection of cyst” or a numeral code such as “701” is a procedure which is assigned a value of $50, “injection of bursa” or a numeral code representation such as “702” is a procedure which is assigned a value of $60; “gall bladder surgery” or a numeral code of “1001” is a surgery which is assigned a value of $800, “pancreas surgery” or a numeral code of “1002” is a surgery which is assigned a value of $2000; “knee arthroscopy” or a numeral code of “801” is assigned a value of $700, or “hip replacement” or a numeral code of “901” is assigned a value of $900. Diverse dollar-and-cent values are assigned or tagged to all chief complaints, diagnosis, treatments, procedures and surgeries to achieve a plurality of menu of lists of above with monetary values for all 70 medical and surgical specialties.

To achieve the objectives of the present invention, using a physician and a patient in a setting as an example, said designated computer/server receive and store said physician-generated digital health and health-care information on said patient. Using said physician's decision or decisions in said physician-generated information, a computer command means for linking said decision or decisions to a price or corresponding prices, respectively, from said computer files computer-automatically processes such as, but not limited to, matching, sorting or merging said decision with price and decisions with corresponding prices to effect said outcome or outcomes. For example, as a result of the above computerized process, an example of said outcome comprises comprise “cold” or “101”—$30, “injection of cyst” or “701”—$50.

According to the present invention, said example is applied to the works of physicians, their decisions and patients in all settings all over the country or the world. Thus, hundreds of thousands or millions of said decisions are created by said physicians which are used and processed by said computers to produce millions of outcomes each and every day.

Even beyond said outcomes, except for human scrutinies of the appropriateness of said physicians' services, there is no human interference as said outcomes computer-automatically result in directing of correct payments to appropriate physicians' bank accounts and the like and of correct postings and displays of said payments on the appropriate computer display screens of said physicians, health-care consumers and buyers.

Although various preferred embodiments of this invention have been described, it will be appreciated by those skilled in the art that adaptations and variations may be made without departing from the spirit of the invention and the scope of the claims.

1. A system of utilizations of physician-generated digital health and health-care information on physicians' patients and said physicians' individual unique identification information for effecting outcomes leading to payments to said physicians for health-care services rendered by said physicians to said patients in a computer or computers in a network of computers wherein said physician-generated digital health and health-care information and said physicians' individual unique identification information produce said outcomes leading to payments to appropriate said physicians comprises:
digital health and health-care information on a patient generated by a physician;
digital health and health-care information on a patient generated by physicians;
digital health and health-care information on patients generated by physicians;
computer files comprising digital health information and their corresponding prices;
computer files comprising digital health-care information and their corresponding prices;
a computerized process of linking a decision in digital health information to a price;
a computerized process of linking decisions in digital health information to corresponding prices;
a computerized process of linking a decision of digital health-care information to a price;
a computerized process of linking decisions in digital health-care information to corresponding prices;
a computer command means for linking a decision in digital health information to a price;
a computer command means for linking decisions in digital health information to corresponding prices;
a computer command means for linking a decision in digital health-care information to a price;
a computer command means for linking decisions in digital health-care information to corresponding prices;
a computerized process of displaying the outcome of linking a decision in digital health information to a price on computer display screens;
a computerized process of displaying the outcome of linking decisions in digital health information to corresponding prices on computer display screens;
a computerized process of displaying the outcome of linking a decision in digital health-care information to a price on computer display screens;
a computerized process of displaying the outcome of linking decisions in digital health-care information to corresponding prices on computer display screens;
a computer command means for displaying the outcome of linking a decision in digital health information to a price on computer display screens;
a computer command means for displaying the outcome of linking decisions in digital health information to corresponding prices on computer display screens;
a computer command means for displaying the outcome of linking a decision in digital health-care information to a price on computer display screens; and
a computer command means for displaying the outcome of linking decisions in digital health-care information to corresponding prices on computer display screens.

2. A system of computerized utilizations of physician-generated digital health and health-care information on physicians' patients and physicians' individual unique identification information for effecting outcomes leading to payments to said physicians for health-care services rendered by said physicians to said patients in a computer or computers in a network of computers wherein said physician-generated digital health and health-care information and said physicians' individual unique identification information computer-automatically produce outcomes leading to payments to appropriate said physicians comprises:
digital health and health-care information on a patient generated by a physician;
digital health and health-care information on a patient generated by physicians;
digital health and health-care information on patients generated by physicians;
computer files comprising digital health information and their corresponding prices;
computer files comprising digital health-care information and their corresponding prices;
a computerized process of linking a decision in digital health information to a price;
a computerized process of linking decisions in digital health information to corresponding prices;
a computerized process of linking a decision of digital health-care information to a price;
a computerized process of linking decisions in digital health-care information to corresponding prices;
a computer command means for linking a decision in digital health information to a price;
a computer command means for linking decisions in digital health information to corresponding prices;
a computer command means for linking a decision in digital health-care information to a price;
a computer command means for linking decisions in digital health-care information to corresponding prices;
a computerized process of displaying the outcome of linking a decision in digital health information to a price on computer display screens;
a computerized process of displaying the outcome of linking decisions in digital health information to corresponding prices on computer display screens;
a computerized process of displaying the outcome of linking a decision in digital health-care information to a price on computer display screens;
a computerized process of displaying the outcome of linking decisions in digital health-care information to corresponding prices on computer display screens;
a computer command means for displaying the outcome of linking a decision in digital health information to a price on computer display screens;
a computer command means for displaying the outcome of linking decisions in digital health information to corresponding prices on computer display screens;
a computer command means for displaying the outcome of linking a decision in digital health-care information to a price on computer display screens; and
a computer command means for displaying the outcome of linking decisions in digital health-care information to corresponding prices on computer display screens.

3. A system of computerized utilizations of physicians' decisions contain in physician-generated digital health and health-care information on physicians' patients in a computer or computers in a network of computers for effecting outcomes leading to payments to appropriate said physicians for health-care services rendered by said physicians to said patients wherein said utilizations are directed in said computer or computers by said physicians' decisions in said physician-generated digital health and health-care information comprises:
digital health and health-care information on a patient generated by a physician;
digital health and health-care information on a patient generated by physicians;
digital health and health-care information on patients generated by physicians;
computer files comprising digital health information and their corresponding prices;
computer files comprising digital health-care information and their corresponding prices;
a computerized process of linking a decision in digital health information to a price;
a computerized process of linking decisions in digital health information to corresponding prices;
a computerized process of linking a decision of digital health-care information to a price;
a computerized process of linking decisions in digital health-care information to corresponding prices;
a computer command means for linking a decision in digital health information to a price;
a computer command means for linking decisions in digital health information to corresponding prices;
a computer command means for linking a decision in digital health-care information to a price;
a computer command means for linking decisions in digital health-care information to corresponding prices;
a computerized process of displaying the outcome of linking a decision in digital health information to a price on computer display screens;
a computerized process of displaying the outcome of linking decisions in digital health information to corresponding prices on computer display screens;
a computerized process of displaying the outcome of linking a decision in digital health-care information to a price on computer display screens;
a computerized process of displaying the outcome of linking decisions in digital health-care information to corresponding prices on computer display screens;
a computer command means for displaying the outcome of linking a decision in digital health information to a price on computer display screens;
a computer command means for displaying the outcome of linking decisions in digital health information to corresponding prices on computer display screens;
a computer command means for displaying the outcome of linking a decision in digital health-care information to a price on computer display screens; and
a computer command means for displaying the outcome of linking decisions in digital health-care information to corresponding prices on computer display screens.
